(19) United States
(12) Patent Application Publication
(10) Pub. No.: US 2018/0148165 A1
(43) Pub. Date: May 31, 2018

(54) ROTOR STATE FEEDBACK SYSTEM

(71) Applicant: Sikorsky Aircraft Corporation, Stratford, CT (US)

(72) Inventors: Derek Geiger, Wilton, CT (US); Seung Bum Kim, Glastonbury, CT (US); Ole Wulff, Ansonia, CT (US); Aaron Kellner, Bloomfield, CT (US); Brian Edward Morris, West Palm Beach, FL (US)

(21) Appl. No.: 15/572,579

(22) PCT Filed: Mar. 11, 2016
(86) PCT No.: PCT/US16/22042

§ 371 Date: Nov. 8, 2017

Related U.S. Application Data
(60) Provisional application No. 62/159,632, filed on May 11, 2015.

(51) Int. Cl. B64C 27/00; B64C 27/10; G05D 1/00; G05D 1/08

(52) U.S. Cl. CPC B64C 27/008; B64C 27/10; B64C 2027/8236; G05D 1/0858; G05D 1/0066

(57) ABSTRACT

A control system is provided and includes a servo control system configured to control aerodynamic element pitching, an optical sensor system disposed along rotor blades to generate an optical response reflective of rotor feedback states of the rotor blades and a processing unit operably coupled between the servo control and optical sensor systems, the processing unit being configured to calculate strain in the rotor blades from the optical response, convert the calculated strain into readings of the rotor feedback states and issue a servo command to the servo control system as an instruction for controlling the aerodynamic element pitching.

### FEDERAL RESEARCH STATEMENT

The following embodiments and aspects were made with government support under the W911W6-13-2-0013 Innovative Rotors and Vehicle Management System Technologies contract awarded by the Army. The government has certain rights in the embodiments and aspects.

### BACKGROUND

The subject matter disclosed herein relates to a rotor state feedback system and, more particularly, to a rotor state feedback system utilizing optical sensors for coaxial rotors.

A coaxial aircraft, such as a coaxial, counter-rotating helicopter, has an airframe that has a top portion and a tail portion extending in the aft direction. The aircraft further includes a main rotor assembly at the top portion and an auxiliary propulsor at the tail portion. Also in the tail portion is an elevator. When driven to rotate by an engine supported within or on the airframe via a transmission, the main rotor assembly, which includes coaxial, counter-rotating rotors, generates lift for the aircraft and the auxiliary propulsor generates thrust. The elevator generates a pitching moment for the aircraft at high speed. The pilot (and crew) and the flight computer can cyclically and collectively control the pitching of the blades of at least the main rotor assembly and the pitch of the elevator to control the flight and navigation of the aircraft.

Control laws for coaxial aircraft are generally developed such that air vehicle loads, tip separation, maneuverability and performance requirements can all be achieved. However, since these control laws may not include rotor state information, they are often designed conservatively to ensure the avoidance of critical tip clearance and load constraints while trading on maneuverability and performance attributes.

### BRIEF DESCRIPTION

According to one aspect, a control system is provided and includes a servo control system configured to control aerodynamic element pitching, an optical sensor system disposed along rotor blades to generate an optical response reflective of rotor feedback states of the rotor blades and a processing unit operably coupled between the servo control and optical sensor systems. The processing unit is configured to calculate strain in the rotor blades from the optical response, convert the calculated strain into readings of the rotor feedback states and issue a servo command to the servo control system as an instruction for controlling the aerodynamic element pitching.

In accordance with additional or alternative embodiments, the aerodynamic element pitching comprises rotor blade pitching and elevator pitching.

In accordance with additional or alternative embodiments, the rotor feedback states include a hub moment, a blade deflection and a lift offset of the rotor blades.

In accordance with additional or alternative embodiments, the blade deflection includes tip clearance and tip path plane components.

In accordance with additional or alternative embodiments, the optical sensor system includes a plurality of fiber optic sensors.

In accordance with additional or alternative embodiments, the processing unit includes a storage unit on which state estimation models are stored for conversions of the calculated strain into the readings of the rotor feedback states, an optical receiver module by which the optical response is received from the optical sensor system, a signal processing unit configured to calculate the strain, a modeling unit configured to convert the calculated strain into the readings of the rotor feedback states by reference to the state estimation models and a command unit configured to generate the servo command in accordance with the readings and by which the servo command is issued to the servo control system.

According to another aspect, a rotorcraft is provided and includes an airframe having an upper portion at which first and second coaxial, counter-rotating rotors are disposed and a tail portion at which an elevator and an auxiliary propulsor are disposed and the servo control system. The servo control system is coupled to the first and second coaxial, counter-rotating rotors and the elevator to control rotor blade and elevator pitching.

According to another aspect, a control system is provided and includes coaxial, counter-rotating rotors, an elevator, a servo control system configured to control blade pitching of each of the blades of the rotors and elevator pitching, an optical sensor system disposed along each of the rotors to generate an optical response reflective of rotor feedback states and a processing unit operably coupled between the servo control and optical sensor systems. The processing unit is configured to calculate strain in the blades from the optical response, convert the calculated strain into readings of the rotor feedback states, and issue a servo command to the servo control system as an instruction for controlling the blade and elevator pitching.

In accordance with additional or alternative embodiments, the coaxial, counter-rotating rotors include upper and lower rotors, which are rotatable about a same rotational axis.

In accordance with additional or alternative embodiments, the rotor feedback states include a hub moment, a blade deflection and a lift offset.

In accordance with additional or alternative embodiments, the blade deflection includes tip clearance and tip path plane components.

In accordance with additional or alternative embodiments, the optical sensor system includes a plurality of fiber optic sensors disposed in or on at least one blade of each rotor.

In accordance with additional or alternative embodiments, the processing unit includes a storage unit on which state estimation models are stored for conversions of the calculated strain into the readings of the rotor feedback states.

In accordance with additional or alternative embodiments, the processing unit includes an optical receiver module by which the optical response is received from the optical sensor system, a signal processing unit configured to calculate the strain, a modeling unit configured to convert the calculated strain into the readings of the rotor feedback states by reference to the state estimation models and a command unit configured to generate the servo command in accordance with the readings and by which the servo command is issued to the servo control system.

According to another aspect, a rotorcraft is provided and includes an airframe having an upper portion at which the coaxial, counter-rotating rotors are disposed and a tail portion at which an elevator and an auxiliary propulsor are disposed and the control system.

These and other advantages and features will become more apparent from the following description taken in conjunction with the drawings.

### BRIEF DESCRIPTION OF THE DRAWINGS

The subject matter, which is regarded as the embodiments, is particularly pointed out and distinctly claimed in the claims at the conclusion of the specification. The foregoing and other features, and advantages are apparent from the following detailed description taken in conjunction with the accompanying drawings in which:

FIG. 1 is a side view of a coaxial, counter-rotating rotorcraft;

FIG. 2 is a front, elevation view of the rotorcraft of FIG. 1;

FIG. 3 is a schematic diagram of components of the rotorcraft of FIG. 1;

FIG. 4 is an enlarged schematic view of a strain gage of the rotorcraft in accordance with embodiments; and

FIG. 5 is a schematic diagram of a processing unit of a flight computer and control system of a rotorcraft.

The detailed description explains embodiments, together with advantages and features, by way of example with reference to the drawings.

### DETAILED DESCRIPTION

As will be described below, a set of fiber optic sensors (e.g. fiber Bragg sensors, Fabry-Perot interferometer sensors or Rayleigh backscatter sensors) and state estimation models can be used to estimate the rotor states of aircraft rotor blades. When a force is applied to one of the blades, e.g. during maneuvering flight, the fiber optic sensors provide an optical response that is converted to information reflective of the rotor feedback states through the use of the state estimation models. This information is used in the flight control computer to generate a suitable main rotor servo and elevator command to attenuate high loads in the rotor system, to accommodate a less conservative rotor design, or, alternatively, allow for a larger operational envelope.

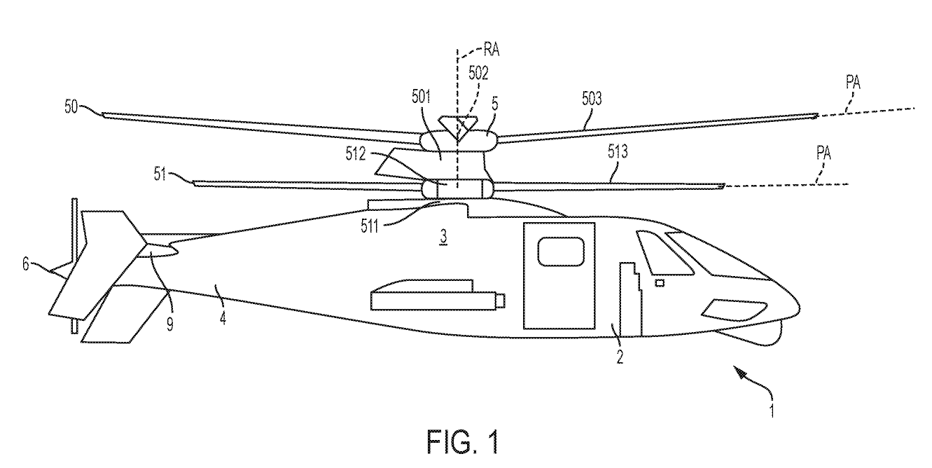

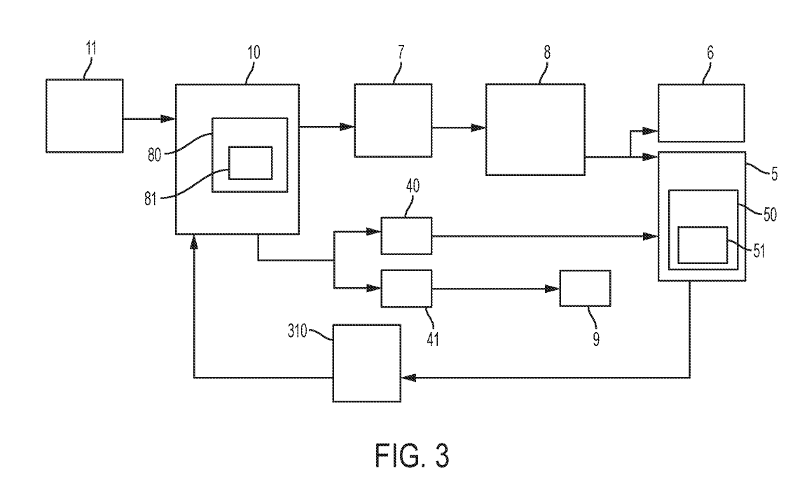

With reference to FIGS. 1-3, a coaxial rotorcraft 1 is provided and may be configured for example as a coaxial, counter-rotating helicopter or some other fixed or variable wing aircraft with single or multiple rotors. The rotorcraft 1 has an airframe 2 that is sized to accommodate a pilot and, in some cases, one or more crewmen and/or passengers as well as control features and a flight computer 10 that hosts a processing unit 80 (see FIG. 3). The airframe 2 has a top portion 3 and a tail portion 4 that extends in the aft direction. The rotorcraft 1 further includes a main rotor assembly 5 at the top portion 3 of the airframe 2, an auxiliary propulsor 6 at the tail portion 4, elevator elements 9 at the tail portion 4, an engine 7 (see FIG. 3) and a transmission 8 (see FIG. 3). The engine 7 may be disposed within or on the airframe 2 and is configured to generate power to drive respective rotations of the main rotor assembly 5 and the auxiliary propulsor 6. The transmission 8 is similarly disposed within or on the airframe 2 and is configured to transmit the power from the engine 7 to the main rotor assembly 5 and the auxiliary propulsor 6.

The main rotor assembly 5 includes a first or upper rotor 50 and a second or lower rotor 51. The upper rotor 50 includes a rotor shaft 501, a hub 502 and blades 503 extending radially outwardly from the hub 502. The rotor shaft 501 and the hub 502 are rotatable in a first direction about rotational axis RA, which is defined through the airframe 2, to drive rotations of the blades 503 about the rotational axis RA in the first direction. The lower rotor 51 includes a rotor shaft 511, a hub 512 and blades 513 extending radially outwardly from the hub 512. The rotor shaft 511 and the hub 512 are rotatable in a second direction about the rotational axis RA, which is opposite the first direction, to drive rotations of the blades 513 about the rotational axis RA in the second direction. The auxiliary propulsor 6 has a similar structure with an axis of rotation that is generally aligned with a longitudinal axis of the tail portion 4.

In extending radially outwardly from the hubs 502, 512, the blades 503, 513 are pivotable about respective pitch axes PA that run along respective longitudinal lengths of the blades 503, 513. This pitching can include lateral cyclic pitching, longitudinal cyclic pitching and collective pitching. Lateral cyclic pitching varies blade pitch with left and right movements and tends to tilt the rotor disks formed by the blades 503 and 513 to the left and right to induce roll movements. Longitudinal cyclic pitching varies blade pitch with fore and aft movements and tends to tilt the rotor disks forward and back to induce pitch nose up or down movements. Collective pitching refers to collective angle of attack control for the blades 503, 513 to increase/decrease torque.

Extending outward from the tail portion is a horizontal tail, which includes the elevator elements 9 that are configured to be movable. In particular, these elevator elements 9 are pivotable about their respective pitch axes. Changing the pitch of the elevator elements 9 generates a pitching moment on the rotorcraft 1.

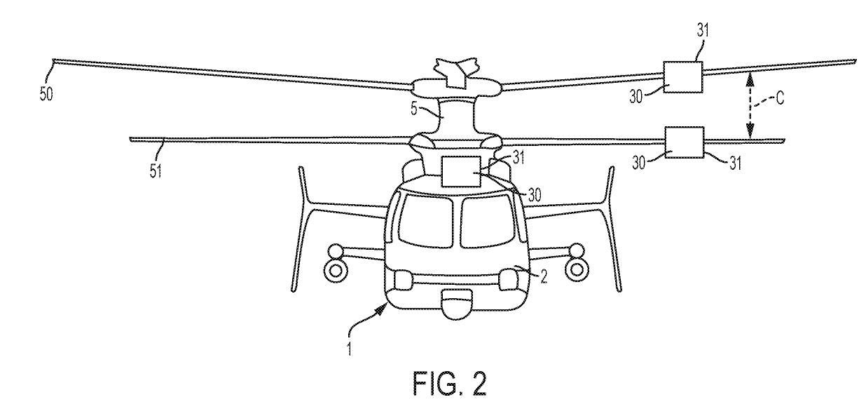

When driven to rotate by the engine 7 via the transmission 8, the main rotor assembly 5 generates lift and the auxiliary propulsor 6 generates thrust. Via inceptors 11 (see FIG. 3), the pilot (and crew) input(s) control commands that are passed to the flight control computer 10 and the processing unit 80, which generates commands for the rotor servo system 40 and elevator servo system 41. The main rotor servo system 40 provides commands to the main rotor assembly 5, which cyclically and collectively controls the pitching of the blades 503, 513, and the elevator servo system 41 manipulates the pitch of the elevator element 9 to control the flight and navigation of the rotorcraft 1 in accordance with the pilot/crew inputted commands and current flight conditions. In doing so, the blades 503, 513 may be monitored to insure that blade tip clearance C (see FIG. 2) is maintained above a predefined minimum distance so that the respective tips of the blades 503 do not impact the respective tips of the blades 513.

The rotorcraft 1 may further include a system of sensors 30. The system of sensors 30 may include a plurality of individual sensors 31 that are respectively disposed on rotating or non-rotating frames of the rotorcraft 1. That is, the sensors 31 can be disposed on the hubs 502, 512, the blades 503, 513 or on the airframe 2. In any case, the sensors 31 can sense or obtain data used to detect longitudinal and lateral hub moments for the upper rotor 50 and the lower rotor 51, blade deflections of the upper and lower rotor blades, blade tip clearances between the blades 503 of the upper rotor 50 and the blades 513 of the lower rotor 51, a lateral and longitudinal lift offset 503 of the upper rotor 50 and the lateral and longitudinal lift offset 513 of the lower rotor 51 (and possibly a pitch rate of the rotorcraft 1 and an attitude of the rotorcraft 1). Based on such sensing capability, the sensors 31 may be further configured to generate strain data to be used to estimate longitudinal and lateral hub moment data, tip clearance data and lateral and longitudinal lift offset data and to issue the same to flight computer 10 and the processing unit 80.

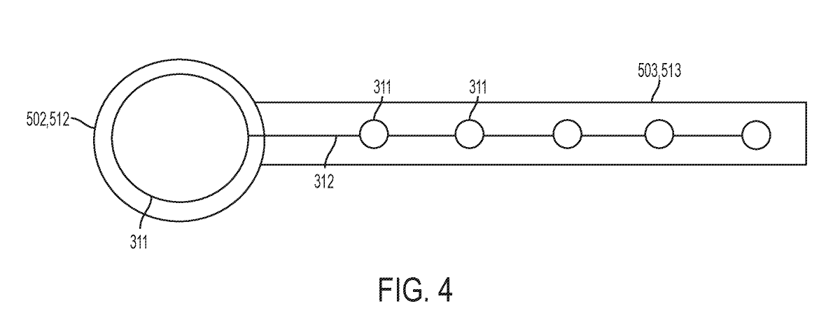

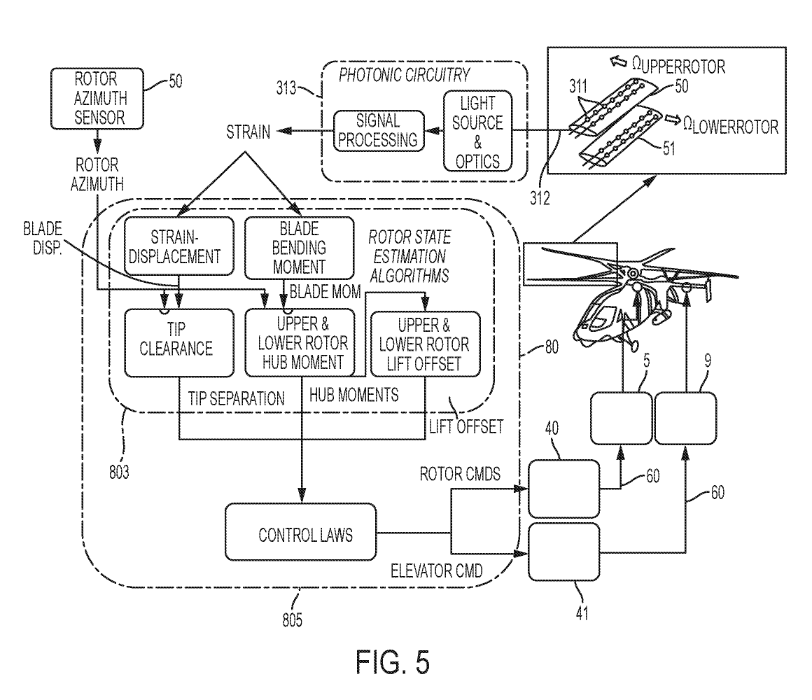

With continued reference to FIG. 3 and additional reference to FIG. 4 and FIG. 5, the sensors 31 may include an optical sensor system 310 that in turn includes photonic circuitry 313, optical sensors 311 and optical fibers 312. The optical sensors 311 may be disposed in or on upper and/or lower surfaces of the blades 503 of the upper rotor 50 and/or in or on upper and/or lower surfaces of the blades 513 of the lower rotor 51. The optical sensors 311 may be provided as fiber Bragg grating (FBG) sensors, Fabry-Perot interferometer (FPI) sensors and/or Rayleigh backscatter sensors. In any case, the optical sensors 311 may be inserted into the blades 503, 513 following blade manufacturing or laid up into the blades 503, 513 as part of the blade manufacturing process. In the former case, the optical sensors 311 may be disposed in a groove formed into the blade material and, in the latter case, the blade material would be formed around the optical sensors 311. In both cases, the optical sensors 311 may be disposed at or proximate to an outermost surface of the blades 503, 513. The optical fibers 312 serve to connect the optical sensors 311 to the photonic circuitry 313. The photonic circuitry 313 may be a component within or connected with wires to the flight computer 10 in series or in parallel.

As shown in FIG. 3 and with reference to FIG. 5, the flight computer 10 may include the above-mentioned processing unit 80 and is connected to the main rotor servo system 40 and the elevator servo system 41. Via the main rotor assembly 5, the main rotor servo system 40 is connected to at least one of the blades 503, 513 of the upper and lower rotors 50 and 51 and configured to control at least a pitching of the corresponding blades 503, 513 about the respective pitch axes. The elevator servo system 41 is similarly coupled with the elevator element 9. The signal of the optical sensor system 310 is delivered to the processing unit 80 in the flight computer 10.

Furthermore, the optical sensor system 310 including the fiber optic sensors 311 and the optical fibers 312 disposed along the blades 503, 513, as noted above, as well as the photonic circuitry 313, is used to generate an optical response signal that is reflective of rotor feedback states of the blades 503, 513. The photonic circuitry 313 includes components that are configured for generating a light source to send to the optical sensors 311 via the optical fibers 312, optics for interrogating the optical response received from the optical sensors 311 and signal processing for generating the strain signal from the interrogated optical signal.

That is, when a force is applied to the blades 503, 513 by the main rotor servo system 40 via the rotor assembly 5 to cause the blades 503, 513 to pitch, the fiber optic sensors 311 can optically sense a change in strain in the blades 503, 513. This strain can then be converted into a measure of deflection of the blades 503, 513 by way of a strain-displacement model, which will be described below, to determine whether the applied force needs to be increased, decreased or maintained.

The processing unit 80 is operably connected between the main rotor servo system 40 and the optical sensor system 310. In that configuration, the processing unit 80 is disposed and configured to calculate rotor feedback states, for example tip clearance, from measurements of strain in blades 503, 513 to be used in the control laws 805 which will generate a servo command to the main rotor servo system 40 and the elevator servo system 41 to in turn control the rotor blade and elevator pitching. To this end, the processing unit 80 may include a storage unit 81 (see FIG. 3) on which state estimation models are stored for conversions of the calculated strain (among other calculated values) into the readings of the rotor feedback states. In accordance with embodiments, the rotor feedback states may include, but are not limited to, a longitudinal and lateral hub moment of the rotors 50, 51, a blade deflection of the blades 503, 513 and a lift offset of the rotors 50, 51. The blade deflection state may further be used to estimated tip clearance and tip path plane components.

As shown in FIG. 5, the processing unit 80 further includes a modeling unit 803 and the above-mentioned control laws 805. The modeling unit 803 is configured to convert the strain signal from the photonic circuitry 313 into the signals of the rotor feedback states through rotor state estimation algorithms utilizing models stored on storage unit 81 and a sensed rotor azimuth 50. The output from the modeling unit 803 is used to generate suitable feedback signals that are processed in the control laws 805 to issue servo commands to the main rotor servo system 40 and the elevator servo system 41.

In accordance with various further embodiments, the modeling unit 803 may include various state estimation models that can be used alone or in combination with each other to generate readings of various rotor feedback states. For example, from the strain sensed by the optical sensor system 310, the modeling unit 803 can generate a tip clearance rotor feedback state reading by reference to an estimated tip displacement model. Similarly, from the strain sensed by the optical sensors 310, the modeling unit 803 can generate hub moment and lift offset rotor feedback state readings by reference to estimated blade load and thrust and lateral moment models, respectively.

With continued reference to FIG. 5, it will be understood that once the servo commands are issued to the main rotor servo system 40 and the elevator servo system 41, forces applied to the blades 503, 513 and the elevator element 9 can be readjusted. In this way, a feedback control loop 60 can be formed to insure that blade strain is accurately controlled.

While embodiments have been described in detail, it should be readily understood that aspects are not limited to such disclosed embodiments. Rather, embodiments can be modified to incorporate any number of variations, alterations, substitutions or equivalent arrangements not heretofore described, but which are commensurate with the spirit and scope of the description. Additionally, while various embodiments have been described, it is to be understood that aspects may include only some of the described embodiments. Accordingly, the aspects are not to be seen as limited by the foregoing description.

What is claimed is:

1. A control system, comprising:
a servo control system configured to control aerodynamic element pitching;
an optical sensor system disposed along rotor blades to generate an optical response reflective of rotor feedback states of the rotor blades; and
a processing unit operably coupled between the servo control and optical sensor systems, the processing unit being configured to calculate strain in the rotor blades from the optical response, convert the calculated strain into readings of the rotor feedback states and issue a servo command to the servo control system as an instruction for controlling the aerodynamic element pitching.

2. The control system according to claim 1, wherein the aerodynamic element pitching comprises rotor blade pitching and elevator pitching.

3. The control system according to claim 1, wherein the rotor feedback states comprise a hub moment, a blade deflection and a lift offset of the rotor blades.

4. The control system according to claim 3, wherein the blade deflection comprises tip clearance and tip path plane components.

5. The control system according to claim 1, wherein the optical sensor system comprises a plurality of fiber optic sensors.

6. The control system according to claim 1, wherein the processing unit comprises:
a storage unit on which state estimation models are stored for conversions of the calculated strain into the readings of the rotor feedback states;
an optical receiver module by which the optical response is received from the optical sensor system;
a signal processing unit configured to calculate the strain;
a modeling unit configured to convert the calculated strain into the readings of the rotor feedback states by reference to the state estimation models; and
a command unit configured to generate the servo command in accordance with the readings and by which the servo command is issued to the servo control system.

7. A rotorcraft, comprising:
an airframe having an upper portion at which first and second coaxial, counter-rotating rotors are disposed and a tail portion at which an elevator and an auxiliary propulsor are disposed; and
the servo control system according to claim 1, the servo control system being coupled to the first and second coaxial, counter-rotating rotors and the elevator to control rotor blade and elevator pitching.

8. A control system, comprising:
coaxial, counter-rotating rotors;
an elevator;
a servo control system configured to control blade pitching of each of the blades of the rotors and elevator pitching;
an optical sensor system disposed along each of the rotors to generate an optical response reflective of rotor feedback states; and
a processing unit operably coupled between the servo control and optical sensor systems, the processing unit being configured to calculate strain in the blades from the optical response, convert the calculated strain into readings of the rotor feedback states, and issue a servo command to the servo control system as an instruction for controlling the blade and elevator pitching.

9. The control system according to claim 8, wherein the coaxial, counter-rotating rotors comprise upper and lower rotors, which are rotatable about a same rotational axis.

10. The control system according to claim 8, wherein the rotor feedback states comprise a hub moment, a blade deflection and a lift offset.

11. The control system according to claim 10, wherein the blade deflection comprises tip clearance and tip path plane components.

12. The control system according to claim 8, wherein the optical sensor system comprises a plurality of fiber optic sensors disposed in or on at least one blade of each rotor.

13. The control system according to claim 8, wherein the processing unit comprises a storage unit on which state estimation models are stored for conversions of the calculated strain into the readings of the rotor feedback states.

14. The control system according to claim 13, wherein the processing unit comprises:
an optical receiver module by which the optical response is received from the optical sensor system;
a signal processing unit configured to calculate the strain;
a modeling unit configured to convert the calculated strain into the readings of the rotor feedback states by reference to the state estimation models; and
a command unit configured to generate the servo command in accordance with the readings and by which the servo command is issued to the servo control system

15. A rotorcraft, comprising an airframe having an upper portion at which the coaxial, counter-rotating rotors are disposed and a tail portion at which an elevator and an auxiliary propulsor are disposed and the control system of claim 8.
